(19) United States
(12) Patent Application Publication
(10) Pub. No.: US 2015/0049626 A1
(43) Pub. Date: Feb. 19, 2015

(54) ENABLING COORDINATED MULTIPOINT (COMP) OPERATION

(71) Applicant: QUALCOMM Incorporated, San Diego, CA (US)

(72) Inventors: Wanshi CHEN, San Diego, CA (US); Peter GAAL, San Diego, CA (US)

(21) Appl. No.: 14/456,245

(22) Filed: Aug. 11, 2014

Related U.S. Application Data
(60) Provisional application No. 61/865,833, filed on Aug. 14, 2013.

(51) Int. Cl. H04W 24/08; H04L 5/00

(52) U.S. Cl. CPC H04W 24/08; H04L 5/0035; H04L 5/0051; H04L 5/0053
USPC 370/252; 370/329

(57) ABSTRACT

Aspects of the present disclosure relate to techniques that may help enable coordinated multipoint (CoMP) operation for devices designed to operate in systems that do not explicitly support CoMP.

### CLAIM OF PRIORITY UNDER 35 U.S.C. §119

This application claims benefit of U.S. Provisional Patent Application Ser. No. 61/865,833, filed Aug. 14, 2013 and entitled “Enabling Coordinated Multipoint (CoMP) Operation”, incorporated by reference in its entirety.

### TECHNICAL FIELD

Certain aspects of the present disclosure generally relate to wireless communications and, more particularly, to techniques for enabling coordinated multipoint (CoMP) operation.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Some systems may utilize a relay base station that relays messages between a donor base station and wireless terminals. The relay base station may communicate with the donor base station via a backhaul link and with the terminals via an access link. In other words, the relay base station may receive downlink messages from the donor base station over the backhaul link and relay these messages to the terminals over the access link. Similarly, the relay base station may receive uplink messages from the terminals over the access link and relay these messages to the donor base station over the backhaul link.

### SUMMARY

Certain aspects of the present disclosure provide a method for wireless communications by a user equipment (UE). The method generally includes receiving signaling indicating first and second subframe subsets for channel state information (CSI) measurement, identifying a complementary subframe subset that include subframes not in the first and second subframe subsets, receiving a transmission triggering aperiodic CSI feedback in a subframe of the complementary subset, performing measurement based at least in part on a CSI reference signal (CSI-RS) configuration for the UE, and providing feedback based on the measurement.

Certain aspects of the present disclosure provide an apparatus for wireless communications. The apparatus generally includes a processor configured to receive signaling indicating first and second subframe subsets for channel state information (CSI) measurement, identify a complementary subframe subset that include subframes not in the first and second subframe subsets, receive a transmission triggering aperiodic CSI feedback in a subframe of the complementary subset, perform measurement based at least in part on a CSI reference signal (CSI-RS) configuration for the apparatus, and provide feedback based on the measurement, and a memory coupled to the processor.

Certain aspects of the present disclosure provide a method for wireless communications by a base station (BS). The method generally includes providing, to a user equipment (UE) an indication of first and second subframe subsets for channel state information (CSI) measurement, sending a transmission to the UE triggering aperiodic CSI feedback in a subframe of a complementary subset that include subframes not in the first and second subframe subsets, and receiving feedback from the UE based on measurement based at least in part on a CSI reference signal (CSI-RS) configuration for the UE.

Certain aspects of the present disclosure provide an apparatus for wireless communications. The apparatus generally includes a processor configured to provide, to another apparatus, an indication of first and second subframe subsets for channel state information (CSI) measurement, send a transmission to the other apparatus triggering aperiodic CSI feedback in a subframe of a complementary subset that include subframes not in the first and second subframe subsets, and receive feedback from the other apparatus based on measurement based at least in part on a CSI reference signal (CSI-RS) configuration for the other apparatus, and a memory coupled to the processor.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system, according to aspects of the present disclosure.

FIG. 2 is a block diagram of a communication system, according to aspects of the present disclosure.

FIG. 3 illustrates an example frame structure, according to aspects of the present disclosure.

FIG. 4 illustrates an example subframe resource element mapping, according to aspects of the present disclosure.

FIG. 5 illustrates examples of homogeneous coordinated multipoint (CoMP) deployment scenarios, in which aspects of the present disclosure may be practiced.

FIG. 6 illustrates examples of heterogeneous CoMP deployment scenarios, in which aspects of the present disclosure may be practiced.

FIG. 7 illustrates example subframe configurations for channel state information (CSI) feedback, in accordance with aspects of the present disclosure.

FIG. 8 illustrates example subframe configurations for periodic CSI feedback, in accordance with aspects of the present disclosure.

FIG. 9 illustrates example subframe configurations for aperiodic CSI feedback, in accordance with aspects of the present disclosure.

FIG. 10 illustrates example subframe configurations for CSI feedback with aperiodic CSI triggering in a complimentary subframe set, in accordance with aspects of the present disclosure.

FIG. 11 illustrates another example subframe configurations for CSI feedback with aperiodic CSI triggering in a complimentary subframe set, in accordance with aspects of the present disclosure.

FIG. 12 illustrates example operations that may be performed by a user equipment (UE), in accordance with aspects of the present disclosure.

FIG. 12A illustrates example means capable of performing the operations shown in FIG. 12.

FIG. 13 illustrates example operations that may be performed by a base station, in accordance with aspects of the present disclosure.

FIG. 13A illustrates example means capable of performing the operations shown in FIG. 13.

### DETAILED DESCRIPTION

According to certain aspects provided herein, user equipments (UEs) may be able to provide feedback based on channel state information reference signals (CSI-RS) measurements that may be used to make decisions for coordinated multipoint (CoMP) transmissions.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

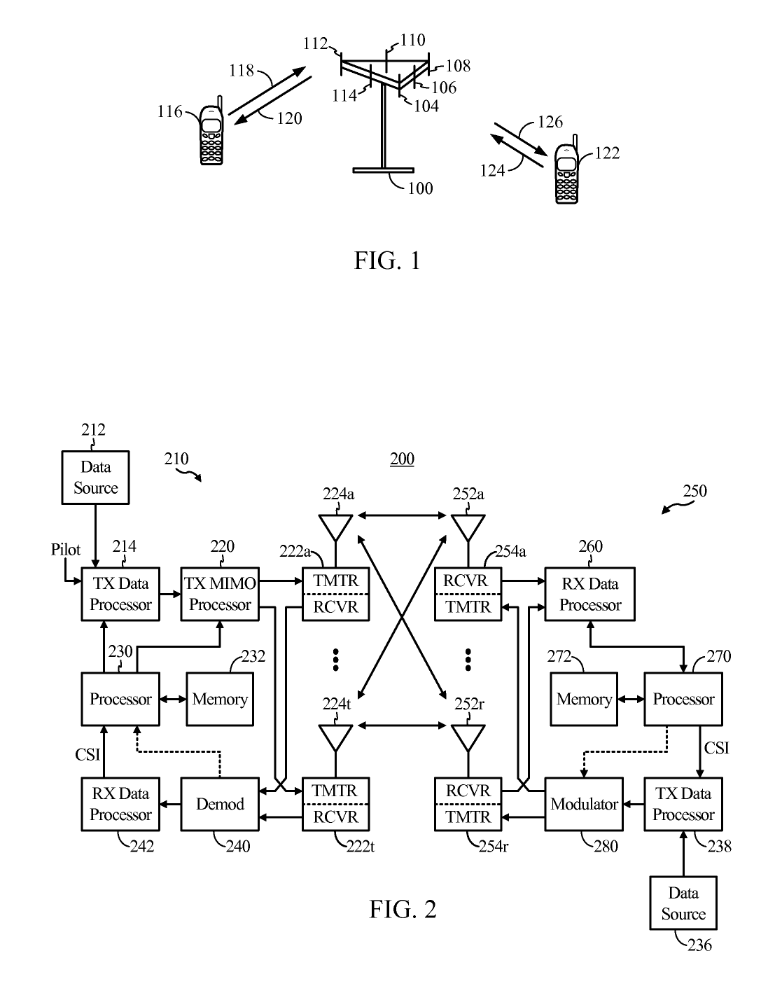

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access point. In the embodiment, antenna groups are each designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an AP using beamforming to transmit to access terminals scattered randomly through its coverage causes less interference to access terminals in neighboring cells than an access point transmitting through a single antenna to all its access terminals.

An AP may be a fixed station used for communicating with the terminals and may also be referred to as an access point, a Node B, base station, evolved Node B (eNB) or some other terminology. An AT may also be called an access terminal, user equipment (UE), a wireless communication device, terminal, mobile station or some other terminology.

FIG. 2 is a block diagram of an embodiment of a transmitter system 210 (also known as an AP) and a receiver system 250 (also known as an AT) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system 250 to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions, from memory 232, performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r, and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights and then processes the extracted message.

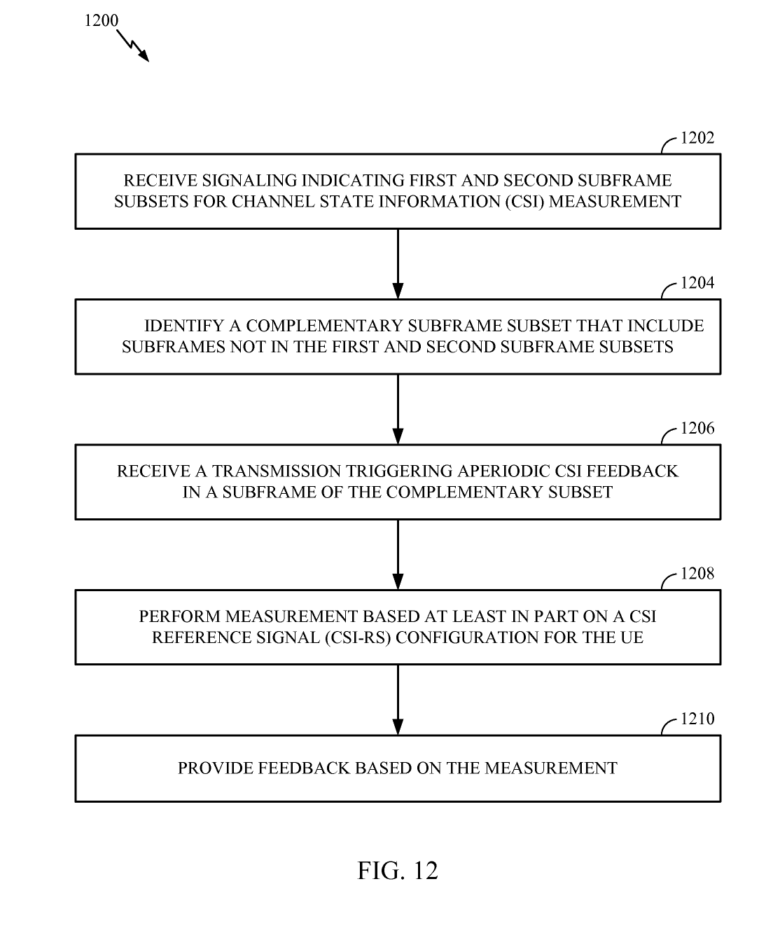

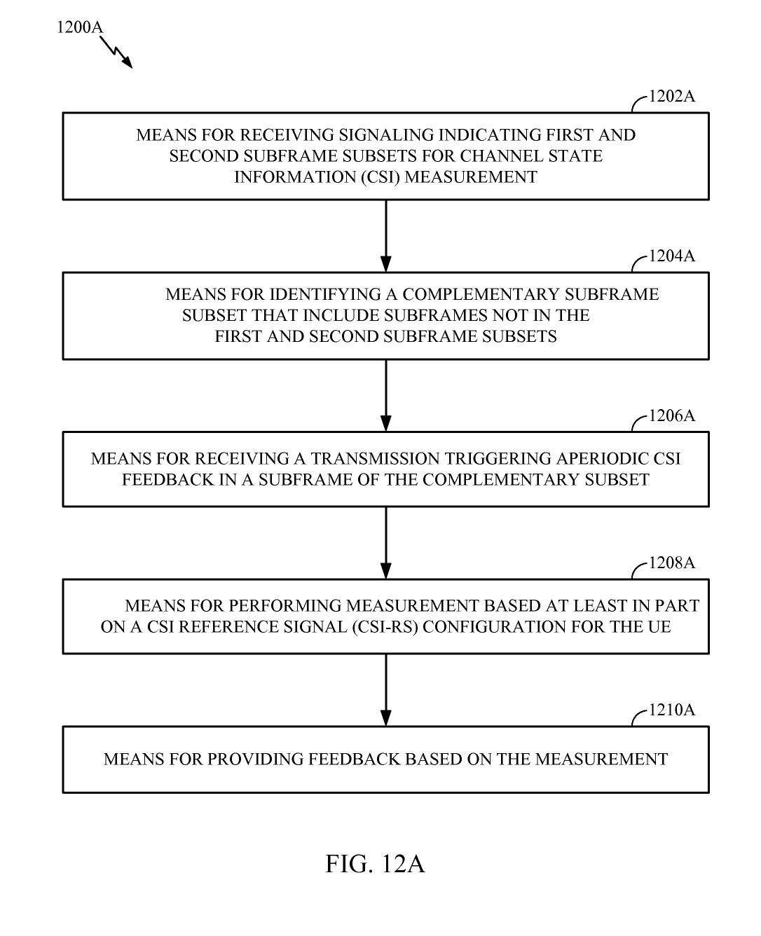

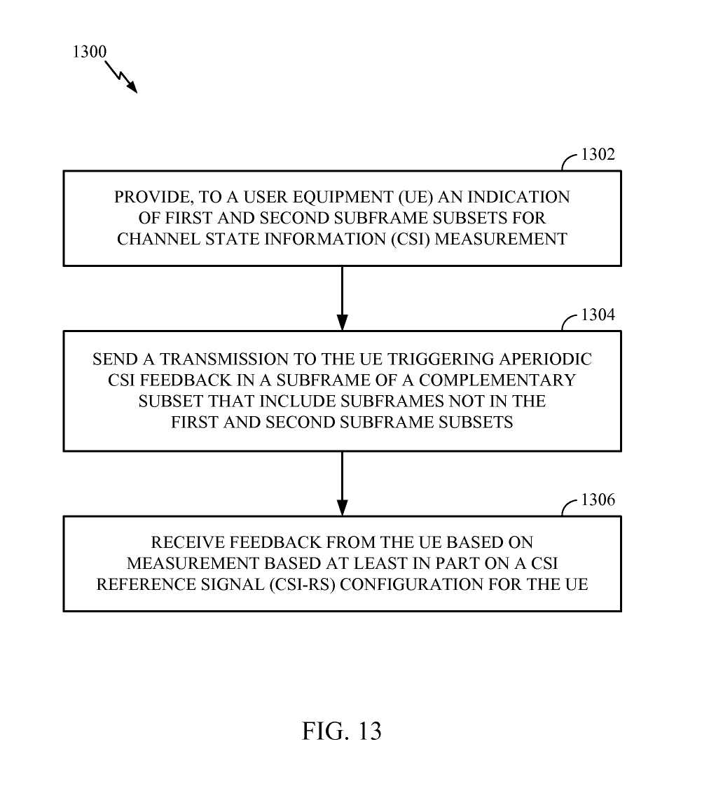

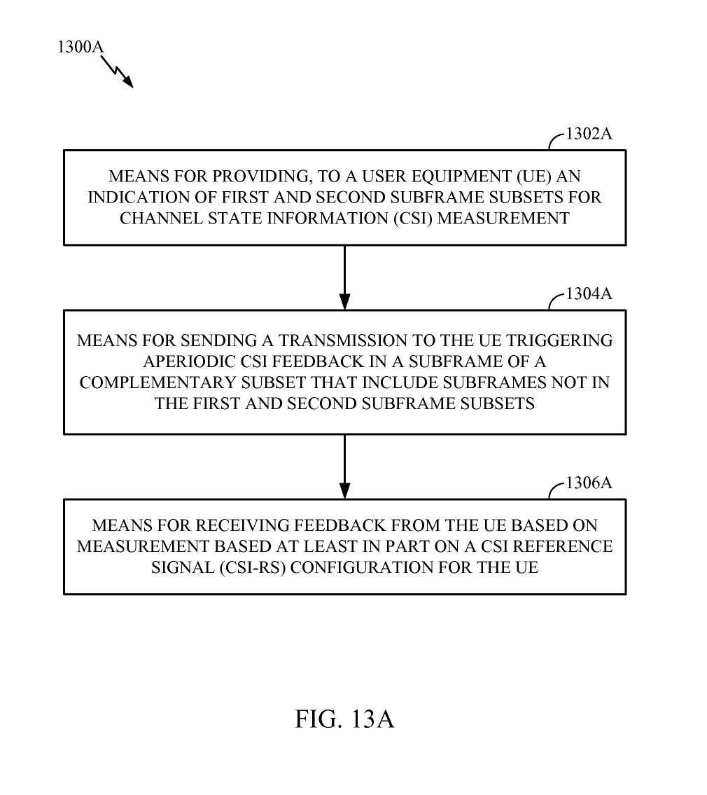

According to aspects, the controllers/processors 230 and 270 may direct the operation at the transmitter system 210 and the receiver system 250, respectively. According to an aspect, the controller/processor 230, TX data processor 214, and/or other processors and modules at the transmitter system 210 may perform or direct operations 1300 in FIG. 13 and/or other processes for the techniques described herein. According to another aspect, the controller/processor 270, RX processor 260, and/or other processors and modules at the receiver system 260 may perform or direct operations 1200 in FIG. 12 and/or other processes for the techniques described herein. However, any other processor or component in FIG. 2 may perform or direct operations 1200 in FIG. 12, operations 1300 in FIG. 13 and/or other processes for the techniques described herein. The memories 232 and 272 may store data and program codes for the transmitter system 210 and the receiver system 260, respectively.

In an aspect, logical channels are classified into Control Channels and Traffic Channels. Logical Control Channels comprise Broadcast Control Channel (BCCH), which is a DL channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing an RRC connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to PHY resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

The DL PHY channels comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprise:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C—Control—

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DL-SCH DownLink Shared CHannel

DM-RS DeModulation-Reference Signal

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

L1 Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RB Resource Block

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U—User—

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN Multimedia Broadcast Single Frequency Network

MCE MBMS Coordinating Entity

MCH Multicast CHannel

MSCH MBMS Control CHannel

PDCCH Physical Downlink Control CHannel

PDSCH Physical Downlink Shared CHannel

PRB Physical Resource Block

VRB Virtual Resource Block

In addition, Rel-8 refers to Release 8 of the LTE standard.

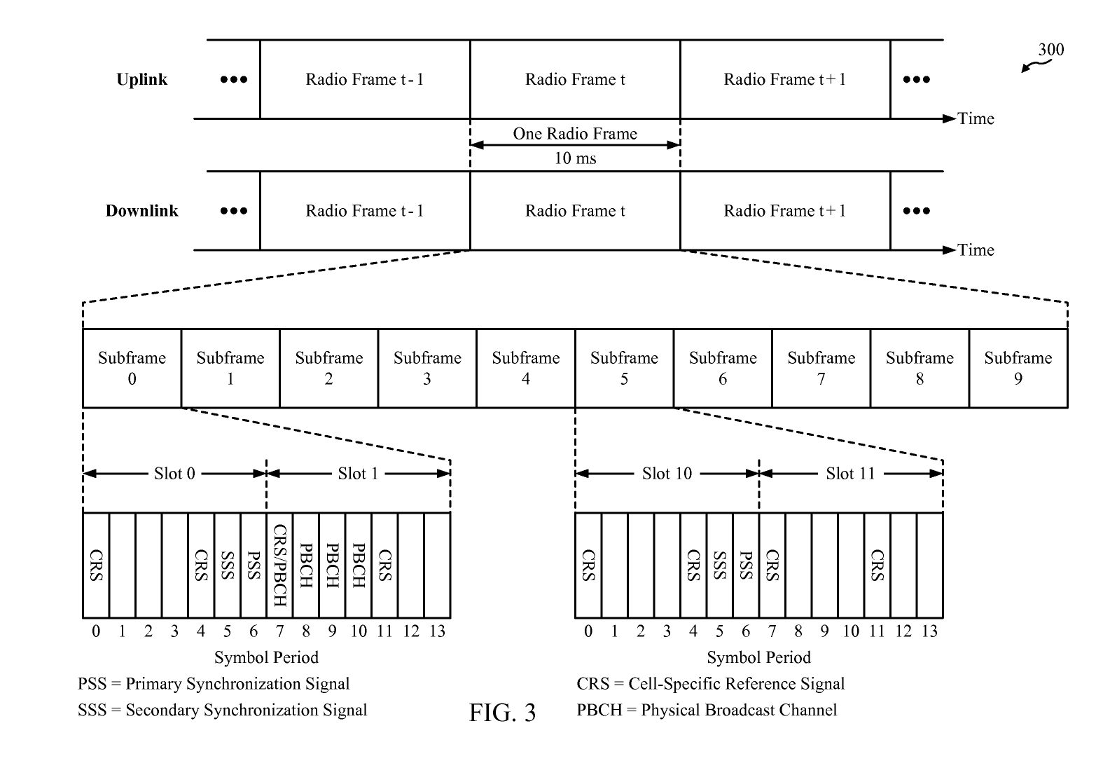

FIG. 3 shows an exemplary frame structure 300 for FDD in LTE, in accordance with certain aspects of the present disclosure. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L−1.

In LTE, an eNB may transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

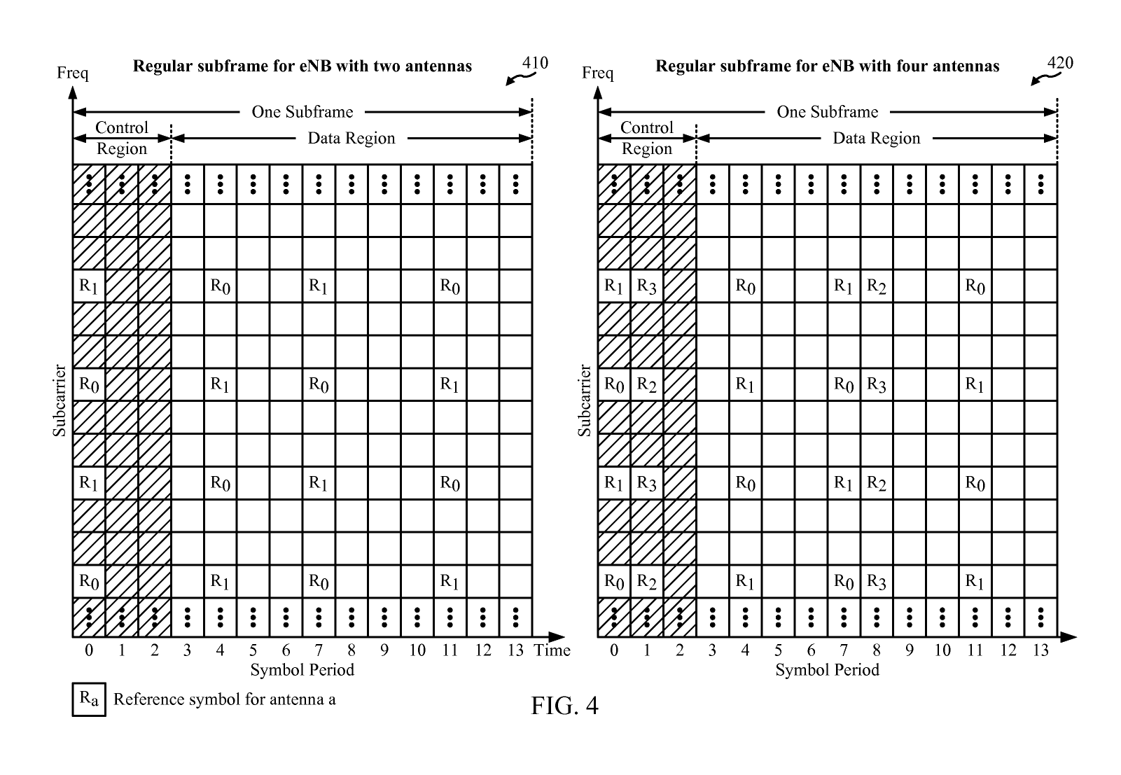

FIG. 4 shows two exemplary subframe formats 410 and 420 for the downlink with the normal cyclic prefix, in accordance with certain aspects of the present disclosure. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where qε{0, . . . , Q−1}.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

For certain aspects of the present disclosure, a UE may be located within the coverage area of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric. The UE may operate in a dominant interference scenario in which the UE may observe high interference from one or more interfering eNBs.

### Example Comp Deployment Scenarios

According to certain aspects, in some cases, as capacity needs of wireless communication networks increase, it may be desirable to enhance the coverage of a wireless communication system. In some cases, coverage may be enhanced by multiple transmission points (e.g., eNodeBs) coordinating to better serve a UE. Such coordinated multipoint (CoMP) systems may involve multiple transmission points serving a UE on a downlink or uplink. In some cases, transmission points may coordinate to reduce interference (e.g., with some transmission points restricting transmission during times others are to transmit). In some cases, multiple transmission points may transmit simultaneously to achieve higher transmit power. Similarly, multiple transmission points may coordinate to serve a UE separately or simultaneously on the uplink.

In certain wireless systems, CoMP may be supported via certain transmission modes. For example, in LTE Release 11, CoMP may be supported in DL transmission mode 10. In this case, a UE can be configured with multiple CSI processes, and may provide separate CSI feedback for each CSI process. Each CSI process may involve one non-zero-power (NZP) CSI-RS configuration used for channel measurement and one interference measurement resource (IMR) configuration (e.g., derived from zero-power (ZP) CSI-RS configuration) used for interference measurement.

Each CSI process may be viewed as being associated with one or more cells of the multiple cells involved in CoMP operation for the UE. A UE may also be dynamically indicated with a set of parameters for PDSCH rate matching and a NZP CSI-RS configuration for Quasi-co-location (QCL) operation (e.g., with DM-RS and/or CRS).

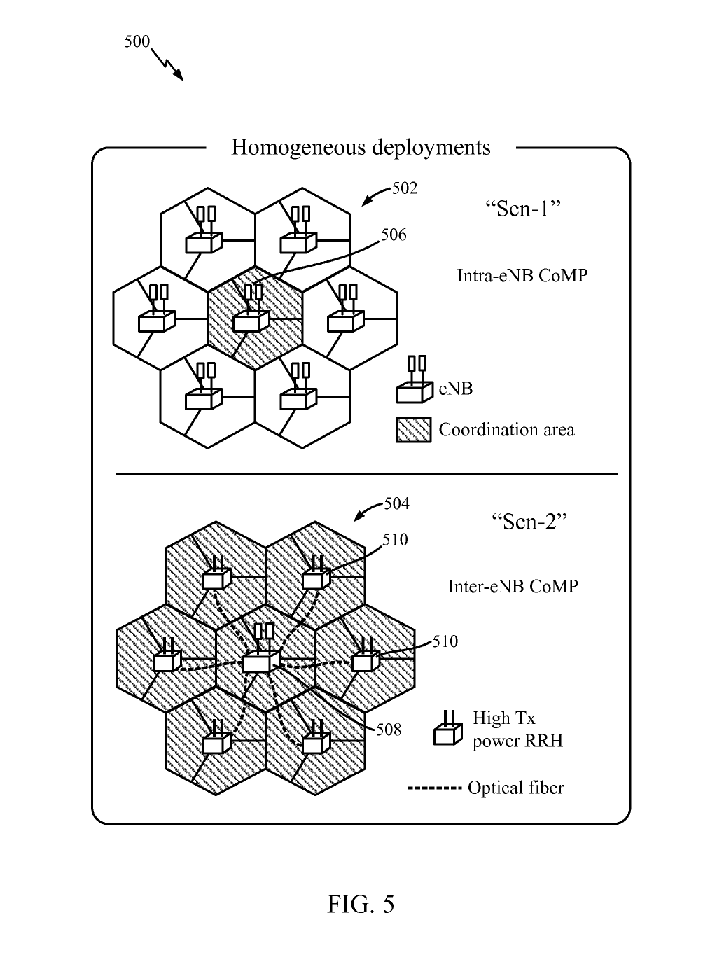

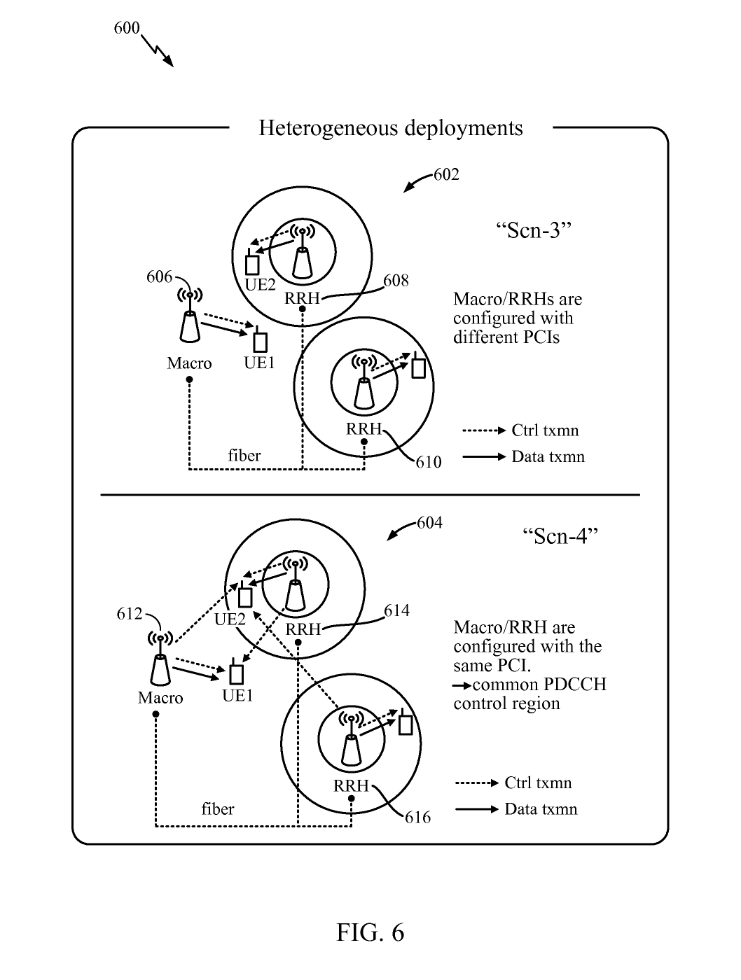

FIGS. 5 and 6 illustrate different CoMP deployment scenarios. As illustrated in FIG. 5, in homogeneous deployment examples 502 and 504, a group of transmission points of the same type (e.g., macro eNBs) may be deployed to serve a UE. In the example 502, a single eNB (e.g., eNB 506) may serve the UE, wherein a plurality of eNBs may be connected through intra-eNB CoMP. In the example 504, a plurality of eNBs may serve the UE simultaneously, wherein a macro eNB 508 may be connected with high transmit (Tx) power remote radio heads (RRHs) 510 using optical fibers making the example system 504 inter-eNB CoMP.

As illustrated in FIG. 6, in heterogeneous deployment examples 602 and 604, a group of transmission points of different types (e.g., a macro eNB and various RRHs) may be deployed to serve a UE. As illustrated in the example 602, a macro eNB 606 and RRHs 608 and 610 may be connected with a fiber for control and data transmissions. In the example 602, the macro eNB 606 and the RRHs 608-610 may be configured with different physical cell identifiers (PCIs).

In the example 604, a Macro eNB and RRHs may be configured with the same PCI resulting into a common PDCCH control region. Thus, for the example 604 of heterogeneous CoMP deployment, a Macro cell (e.g., defined by a Macro eNB 612) and its associated small cells (e.g., defined by RRHs 614 and 616) may be configured with the same CRS. For certain aspects, two or more NZP CSI-RS configurations (with a same or different virtual cell IDs) and two or more IMR configurations may be necessary to differentiate different cells of the same CRS.

In certain wireless systems, CoMP may not be explicitly supported although various CSI-RS reporting mechanism may be used. For example, in LTE Rel-10, for a UE in transmission mode 9 when a parameter precoding matrix index—rank indicator report (PMI-RI-Report) is configured by higher layers, the UE may derive the channel measurements for computing the channel quality indicator (CQI) value reported in an uplink subframe n based on only NZP CSI-RS. For a UE in transmission mode 9, when the parameter PMI-RI-Report is not configured by higher layers or in other transmission modes, the UE may derive the channel measurements for computing CQI based on a cell-specific reference signal (CRS).

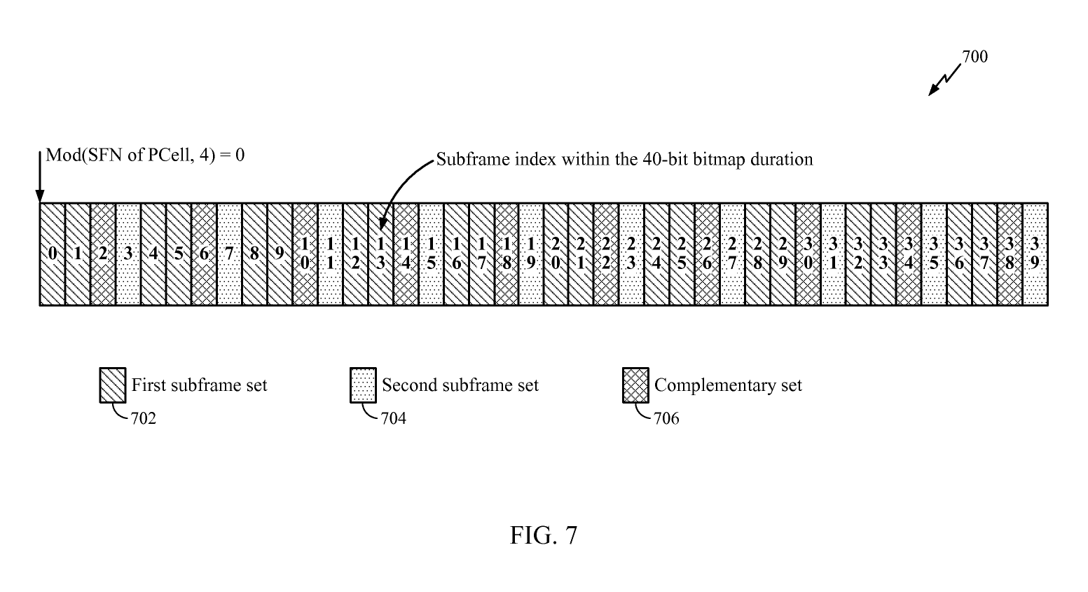

As illustrated in an example subframe configuration 700 in FIG. 7, a Rel-10 UE can be configured with two restricted subframe subsets 702 and 704 (subframe subsets C_{CSI,1} and C_{CSI,2}, respectively) for CSI measurement. In an aspect of the present disclosure, the subframe subsets C_{CSI,1} and C_{CSI,2} may be defined as:
C_{CSI,1}: csi-MeasSubframeSet1-r10
C_{CSI,2}: csi-MeasSubframeSet2-r10

If configured, the two subframe subsets (C_{CSI,1} and C_{CSI,2}) may be configured on a per UE basis. The configuration may be applicable to all the supported DL transmission modes for Rel-10 UEs. As illustrated in FIG. 7, the two subframe sets 702 and 704 (C_{CSI,1} and C_{CSI,2}) are not expected to be overlapped. If overlapped, the UE may treat this overlap as a miss-configuration.

For certain aspects of the present disclosure, a complementary subframe subset 706 illustrated in the example subframe configuration 700 in FIG. 7 may be defined as:

C_{Complementary}=C_{AllDLSubframes}−C_{CSI,1}−C_{CSI,2},

where C_{AllDLsubframes} denotes a set of all downlink subframes, which may include special subframes in TDD systems. In an aspect, the complementary set for a UE can be empty. In another aspect, the complementary set for a UE can be non-empty. In this aspect, a subframe in the complementary set is never considered a valid reference subframe for a periodic CSI (P-CSI) report.

In some cases, there may be a one-to-one mapping between C_{CSI,i} (where i=1 and 2) and the periodic CSI configuration sets, specifically:
C_{CSI,1}←→{cqi-pmi-ConfigIndex,ri-ConfigIndex}
C_{CSI,2}←→{cqi-pmi-ConfigIndex2,ri-ConfigIndex2}
   In one aspect of the present disclosure, if only set 1 {cqi-pmi-ConfigIndex, ri-Configlndex} is configured, CSI reporting may be only based on C_{CSI,1}. In another aspect, if both sets are configured, each periodic CSI feedback may belong to one (and only one) of the two sets.

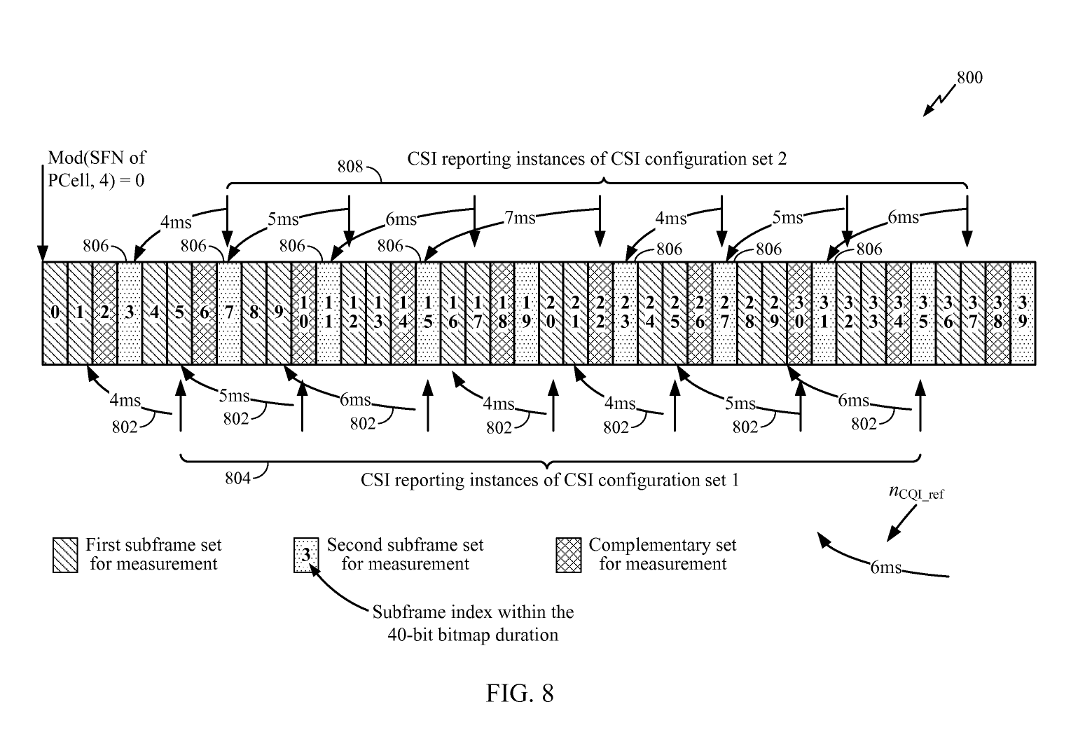

FIG. 8 illustrates an example subframe configuration 800, in accordance with certain aspects of the present disclosure. As illustrated in FIG. 8, a measurement subframe n-n_{CQI}_{_{—}}_{ref} may be utilized for a CSI report within a subframe n. In one aspect, when CSI configuration set 1 is defined, CSI reporting instances 804 (subframes n) may be based on measurement subframes 802 (subframes n-n_{CQI}_{_{—}}_{ref}). In another aspect, when CSI configuration set 2 is defined, CSI reporting instances 808 (subframes n) may be based on measurement subframes 806 (subframes n-n_{CQI}_{_{—}}_{ref}).

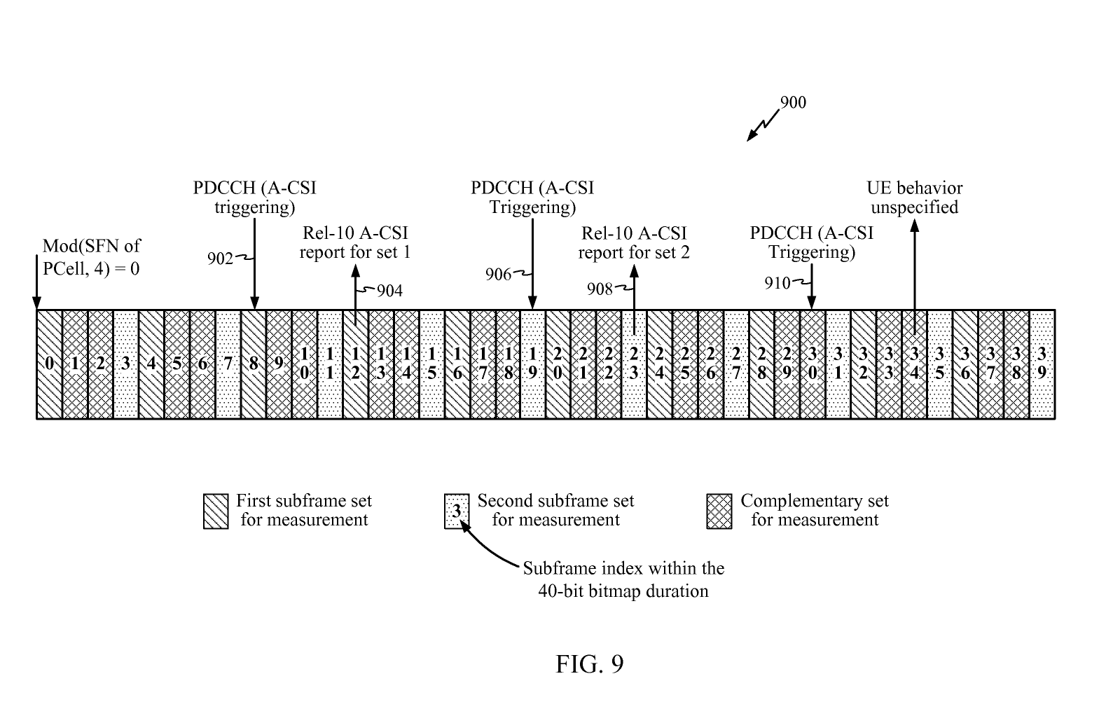

For Aperiodic-CSI (A-CSI) reporting, n_{CQI}_{_{—}}_{ref} may be of a value such that the reference resource is in the same valid downlink subframe as the corresponding CSI request in an uplink DCI format. For example, for FDD, n_{CQI}_{_{—}}_{ref} may be equal to 4, as illustrated in an example subframe configuration 900 in FIG. 9. As illustrated in FIG. 9, A-CSI triggering in a measurement subframe 902 of a first subframe set may result into A-CSI report 904 (A-CSI report for the first subframe set). In addition, A-CSI triggering in a measurement subframe 906 of a second subframe set may result into A-CSI report 908 (A-CSI report for the first subframe set).

In the case of a Random Access Response Grant, the value of n_{CQI}_{_{—}}_{ref} may be again equal to 4 and a downlink subframe n-n_{CQI}_{_{—}}_{ref} should correspond to a valid downlink subframe, where the downlink subframe n-n_{CQI}_{_{—}}_{ref} is received after the subframe with the corresponding CSI request in the Random Access Response Grant. However, as discussed earlier, a UE is not expected to receive a CSI trigger for which the CSI reference resource belongs to the complementary set (e.g., the CSI trigger 910 in FIG. 9). When the PDCCH containing A-CSI triggering is received in a subframe belonging to the complementary set, UE behavior is unspecified, as illustrated in FIG. 9.

### Enabling Comp Operation

Aspects of the present disclosure may enable transparent CoMP operations, by altering how a UE uses a complementary set of restricted subframes. For example, to enable transparent operations, a UE not explicitly designed to support CoMP (e.g., an LTE Rel-10 UE) may be configured with restricted subframe measurements with a non-empty complementary set C_{Complementary}. In an aspect of the present disclosure, CSI feedback may be triggered and/or enabled from the non-empty complementary set to facilitate operation, at least for A-CSI feedback. For example, if a UE receives A-CSI triggering in a subframe belonging to the complementary set, the UE may take action to measure and report in a determined manner.

For example, in one aspect of the present disclosure, the UE may perform measurement based on a NZP CSI-RS configuration (channel measurement part) and a ZP CSI-RS configuration (interference measurement part) configured for the UE. The channel and interference measurement subframes may or may not be the same (e.g., depending on NZP CSI-RS and ZP CSI-RS configurations). In another aspect, a UE may still be configured with a single NZP CSI-RS configuration (e.g., as in LTE Rel-10), but the configuration may be used differently for C_{CSI,1}, C_{CSI,2}, and C_{Complementary} subframe sets. In yet another aspect, a UE may still be configured with a single ZP CSI-RS configuration (e.g., as in LTE Rel-10), but the configuration can be additionally used for interference measurement under some conditions. In some cases, such measurement may not be filtered (e.g., may be a one-shot measurement rather than based on multiple measurements being averaged).

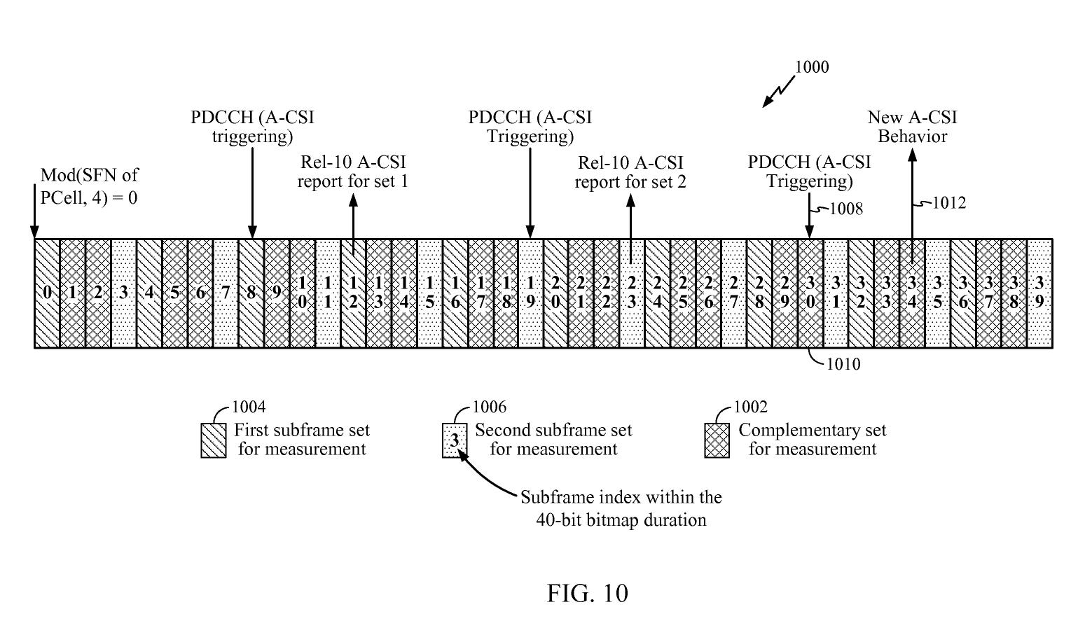

FIG. 10 illustrates an example subframe configuration 1000 with three types of CSI-RS feedback described above, in accordance with certain aspects of the present disclosure. As illustrated in FIG. 10, to ensure a non-empty complementary set 1002, the first and second restricted subframe subsets 1004 and 1006 may be smaller than those shown in FIGS. 7-9. As illustrated in FIG. 10, when PDCCH containing A-CSI triggering 1008 is received in a subframe 1010 belonging to the complementary set 1002, UE behavior for A-CSI feedback reporting 1012 may be defined as specified above.

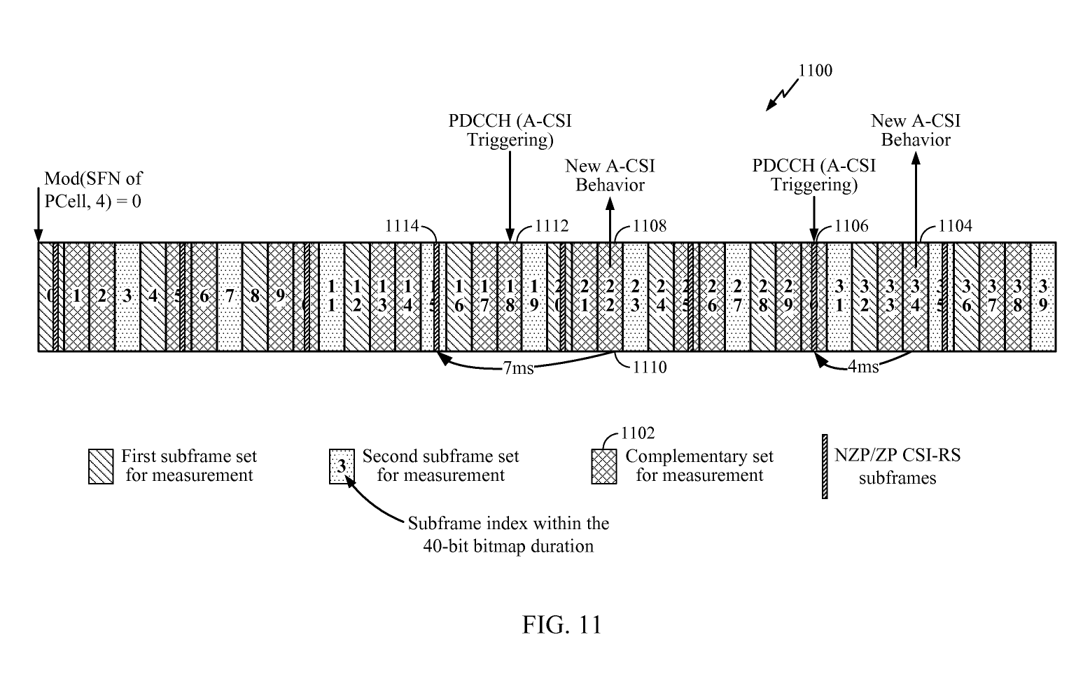

FIG. 11 illustrates an example subframe configuration 1100 showing one exemplary reference subframes subset for measurement for the new CSI type, in accordance with certain aspects of the present disclosure. As illustrated in FIG. 11, while a transmission triggering an A-CSI report may come within a subframe in the complementary subframe subset 1102, the particular subframe containing NZP CSI-RS and the particular subframe ZP CSI-RS may or may not be in the complementary set 1102. As indicated earlier, the subframes for NZP CSI-RS and ZP CSI-RS may or may not be in the same subframe, although FIG. 11 illustrates the case when both fall into the same subframe. For example, while the NZP/ZP CSI-RS for the A-CSI report 1104 may fall in a subframe 1106 that triggered the report 1104, for the A-CSI report 1108 sent in a subframe 1110 (triggered in a subframe 1112), the CSI-RS used for measurement may be placed in a subframe 1114.

In an aspect of the present disclosure, the NZP CSI-RS configuration mapped to the complementary set may correspond to one cell, e.g., to enable dynamic point switching (DPS) type or coordinated beam forming (CBF) type of CoMP. In another aspect, the NZP CSI-RS configuration mapped to the complementary set may correspond to two or more cells, e.g., to enable joint transmission (JT) type CoMP.

For certain aspects of the present disclosure, PDSCH rate matching may always be based on the serving cell. In an aspect, Quasi co-location (QCL) operation may be the same as in LTE Rel-10, i.e., CSI, CRS, and/or DM-RS may be considered being quasi-co-located.

In accordance with certain aspects of the present disclosure, additional changes may be possible. For example, the reference subframe for channel/interference measurement for A-CSI reporting triggered by PDCCH in a subframe in the complementary set can be linked to the latest NZP and/or ZP CSI-RS subframe at or before the PDCCH subframe and the NZP/ZP CSI-subframe is not in the subframe set C_{CSI,1}. Further, in some cases, QCL may be linked with the latest NZP CSI-RS subframe (e.g., QCL-ed with DM-RS) if the UE is triggered for A-CSI reporting in a complementary subframe. However, this may be subject to misalignment between eNB and UE due to PDCCH miss-detection.

For certain aspects of the present disclosure, cell-specific reference signals (CRSs) may be assumed to be non-quasi-co-located with a demodulation reference signal (DM-RS) in a subframe. As an example, in the heterogeneous CoMP deployment scenario 604 illustrated in in FIG. 6, a same CRS may be transmitted from multiple nodes, while DM-RS may be transmitted from a single node. In this case, a UE may assume that CRS and DM-RS are not quasi-co-located at least for the case when A-CSI is triggered in a complementary subframe. In some cases, the ZP CSI-RS configuration may comprise a 16-bit bitmap and each bit in the bitmap may correspond to four resource elements. In an aspect of the present disclosure, all resource elements corresponding to the enabled bit in the ZP CSI-RS configuration may be utilized for interference measurement. In another aspect, only a subset of resource elements may be utilized for interference measurement. As a result, only the four resource elements corresponding to a first bit set in the bitmap may be utilized for interference measurement. In accordance with certain aspects of the present disclosure, for periodic CSI (P-CSI), it may be possible to configure a third set of P-CSI configuration parameters, linked to the complementary set of subframes, to enable P-CSI reporting corresponding to the complementary set.

FIG. 12 illustrates example operations 1200 for wireless communications that may be performed by a user equipment (UE), in accordance with aspects of the present disclosure.

The operations 1200 may begin, at 1202, by receiving signaling indicating first and second subframe subsets for channel state information (CSI) measurement. At 1204, the UE may identify a complementary subframe subset that include subframes not in the first and second subframe subsets. At 1206, the UE may receive a transmission triggering aperiodic CSI feedback in a subframe of the complementary subset. At 1208, the UE may perform measurement based at least in part on a CSI reference signal (CSI-RS) configuration for the UE. At 1210, the UE may provide feedback based on the measurement.

FIG. 13 illustrates example operations 1300 for wireless communications that may be performed by a base station (BS), an access point, or eNB, in accordance with aspects of the present disclosure. The operations 1300 may be considered complementary to those shown in FIG. 12 and may be performed, for example, by an eNB, such as the eNB participating in the CoMP deployment scenario 604 illustrated in FIG. 6.

The operations 1300 may begin, at 1302, by providing, to a user equipment (UE) an indication of first and second subframe subsets for channel state information (CSI) measurement. At 1304, the BS may send a transmission to the UE triggering aperiodic CSI feedback in a subframe of a complementary subset that include subframes not in the first and second subframe subsets. At 1306, the BS may receive feedback from the UE based on measurement based at least in part on a CSI reference signal (CSI-RS) configuration for the UE.

In some cases, the UE may be configured with a downlink transmission mode where CSI-RS is not used for CSI feedback for at least one of channel estimation or interference estimation, and for at least one of the first or second subframe subsets. As described above, in some cases, the first and second subframe subsets may be non-overlapping. As described above, the measurement may be performed based on a non-zero power (NZP) CSI-RS configuration (e.g., for channel information) and a zero power (ZP) CSI-RS configuration (e.g., for interference measurement). The subframes for the NZP CSI-RS and ZP CSI-RS configurations may be different.

In some cases, the UE may be configured with a non-zero power (NZP) CSI-RS configuration and the NZP CSI-RS configuration may be used differently for the first, second, and complementary subframe subsets. In some cases, the UE may be configured with a zero power (ZP) CSI-RS configuration and at least a subset of resource elements corresponding to the ZP CSI-RS configuration may be used for interference measurement. In such cases, the ZP CSI-RS configuration may include a 16-bit bitmap, wherein each bit in the bitmap may correspond to four resource elements, and the at least a subset of resource elements may comprise four resource elements corresponding to a first bit set in the bitmap.

In some cases, the feedback may be based on unfiltered single measurements (e.g., rather than averaged). The measurement may be based on CSI-RS in a subframe that is not part of the first subframe subset. In some cases, the CSI-RS configuration may comprise a non-zero power (NZP) CSI-RS configuration, and the corresponding NZP CSI-RS may be from a first cell in a first subframe and from a second cell in a second subframe.

In some cases, the UE may also determine quasi-co-location between a demodulation reference signal (DM-RS) in the subframe and a CSI reference signal (CSI-RS) before or at the subframe. In some cases, the demodulation reference signal (DM-RS) in the subframe may be determined not to be quasi-co-located with a cell-specific reference signal (CRS).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 1200 and 1300 illustrated in FIG. 12 and FIG. 13 correspond to means 1200A and 1300A illustrated in FIG. 12A and FIG. 13A.

The various operations of methods described above may be performed by any suitable combination of hardware and/or software component(s) and/or module(s).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communication by a user equipment (UE), comprising:
receiving signaling indicating first and second subframe subsets for channel state information (CSI) measurement;
identifying a complementary subframe subset that include subframes not in the first and second subframe subsets;
receiving a transmission triggering aperiodic CSI feedback in a subframe of the complementary subset;
performing measurement based at least in part on a CSI reference signal (CSI-RS) configuration for the UE; and
providing feedback based on the measurement.

2. The method of claim 1, wherein the UE is configured with a downlink transmission mode where CSI-RS is not used for CSI feedback for at least one of channel estimation or interference estimation, for at least one of the first or second subframe subsets.

3. The method of claim 1, wherein the first and second subframe subsets are non-overlapping.

4. The method of claim 1, wherein performing the measurement comprises performing the measurement based on:
a non-zero power (NZP) CSI-RS configuration; and
a zero power (ZP) CSI-RS configuration.

5. The method of claim 4, wherein measurement subframes for the NZP CSI-RS and ZP CSI-RS configurations are different.

6. The method of claim 1, wherein:
the UE is configured with a non-zero power (NZP) CSI-RS configuration; and
the NZP CSI-RS configuration is used differently for the first, second, and complementary subframe subsets.

7. The method of claim 1, wherein:
the UE is configured with a zero power (ZP) CSI-RS configuration; and
at least a subset of resource elements corresponding to the ZP CSI-RS configuration are used for interference measurement.

8. The method of claim 7, wherein the ZP CSI-RS configuration comprises a 16-bit bitmap, each bit in the bitmap corresponds to four resource elements, and the at least a subset of resource elements comprise four resource elements corresponding to a first bit set in the bitmap.

9. The method of claim 1, wherein the measurement is based on CSI-RS in a subframe that is not part of the first subframe subset.

10. The method of claim 1, wherein the CSI-RS configuration comprises a non-zero power (NZP) CSI-RS configuration, and the corresponding NZP CSI-RS is from a first cell in a first subframe and from a second cell in a second subframe.

11. The method of claim 1, further comprising determining quasi-co-location between a demodulation reference signal (DM-RS) in the subframe and a CSI reference signal (CSI-RS) before or at the subframe.

12. The method of claim 11, wherein the demodulation reference signal (DM-RS) in the subframe is determined not to be quasi-co-located with a cell-specific reference signal (CRS).

13. An apparatus for wireless communication, comprising:
a processor configured to:
receive signaling indicating first and second subframe subsets for channel state information (CSI) measurement;
identify a complementary subframe subset that include subframes not in the first and second subframe subsets;
receive a transmission triggering aperiodic CSI feedback in a subframe of the complementary subset;
perform measurement based at least in part on a CSI reference signal (CSI-RS) configuration for the apparatus; and
provide feedback based on the measurement; and
a memory coupled to the processor.

14. The apparatus of claim 13, wherein the apparatus is configured with a downlink transmission mode where CSI-RS is not used for CSI feedback for at least one of channel estimation or interference estimation, for at least one of the first or second subframe subsets.

15. The apparatus of claim 13, wherein the first and second subframe subsets are non-overlapping.

16. The apparatus of claim 13, wherein the processor is also configured to perform the measurement based on:
a non-zero power (NZP) CSI-RS configuration; and
a zero power (ZP) CSI-RS configuration.

17. The apparatus of claim 13, wherein the CSI-RS configuration comprises a non-zero power (NZP) CSI-RS configuration, and the corresponding NZP CSI-RS is from a first cell in a first subframe and from a second cell in a second subframe.

18. A method for wireless communication by an access point, comprising:
providing, to a user equipment (UE), an indication of first and second subframe subsets for channel state information (CSI) measurement;
sending a transmission to the UE triggering aperiodic CSI feedback in a subframe of a complementary subset that include subframes not in the first and second subframe subsets; and
receiving feedback from the UE based on measurement based at least in part on a CSI reference signal (CSI-RS) configuration for the UE.

19. The method of claim 18, wherein the first and second subframe subsets are non-overlapping.

20. The method of claim 18, wherein the feedback is based on measurement performed by the UE based on:
a non-zero power (NZP) CSI-RS configuration; and
a zero power (ZP) CSI-RS configuration.

21. The method of claim 20, wherein measurement subframes for the NZP CSI-RS and ZP CSI-RS configurations are different.

22. The method of claim 18, wherein:
the UE is configured with a non-zero power (NZP) CSI-RS configuration; and
the NZP CSI-RS configuration is used differently for the first, second, and complementary subframe subsets.

23. The method of claim 18, wherein:
the UE is configured with a zero power (ZP) CSI-RS configuration; and
at least a subset of resource elements corresponding to the ZP CSI-RS configuration are used for interference measurement.

24. The method of claim 23, wherein the ZP CSI-RS configuration comprises a 16-bit bitmap, each bit in the bitmap corresponds to four resource elements, and the at least a subset of resource elements comprise four resource elements corresponding to a first bit set in the bitmap.

25. The method of claim 18, wherein the measurement is based on CSI-RS in a subframe that is not part of the first subframe subset.

26. The method of claim 18, wherein the CSI-RS configuration comprises a non-zero power (NZP) CSI-RS configuration, and the corresponding NZP CSI-RS is from a first cell in a first subframe and from a second cell in a second subframe.

27. An apparatus for wireless communication, comprising:
a processor configured to:
provide, to another apparatus, an indication of first and second subframe subsets for channel state information (CSI) measurement;
send a transmission to the other apparatus triggering aperiodic CSI feedback in a subframe of a complementary subset that include subframes not in the first and second subframe subsets; and
receive feedback from the other apparatus based on measurement based at least in part on a CSI reference signal (CSI-RS) configuration for the other apparatus; and
a memory coupled to the processor.

28. The apparatus of claim 27, wherein the first and second subframe subsets are non-overlapping.

29. The apparatus of claim 27, wherein the measurement is based on CSI-RS in a subframe that is not part of the first subframe subset.

30. The apparatus of claim 27, wherein the CSI-RS configuration comprises a non-zero power (NZP) CSI-RS configuration, and the corresponding NZP CSI-RS is from a first cell in a first subframe and from a second cell in a second subframe.
